(19) United States
(12) Patent Application Publication
(10) Pub. No.: US 2018/0371589 A1
(43) Pub. Date: Dec. 27, 2018

(54) SOFT-MAGNETIC ALLOY

(71) Applicant: LG INNOTEK CO., LTD., Seoul (KR)

(72) Inventors: Hyo Yun JUNG, Seoul (KR); Ji Yeon SONG, Seoul (KR); Sang Won LEE, Seoul (KR); So Yeon KIM, Seoul (KR); Seok BAE, Seoul (KR); Jai Hoon YEOM, Seoul (KR); Jong Soo HAN, Seoul (KR)

(73) Assignee: LG INNOTEK CO., LTD., Seoul (KR)

(21) Appl. No.: 15/773,954

(22) PCT Filed: Nov. 7, 2016
(86) PCT No.: PCT/KR2016/012732

§ 371 Date: May 4, 2018

(30) Foreign Application Priority Data
Nov. 6, 2015 (KR) 10-2015-0156059

(51) Int. Cl. C22C 38/40; C22C 38/34; C22C 38/06; H01F 1/147

(52) U.S. Cl. CPC C22C 38/40; C22C 38/34; C22C 2202/02; H01F 1/14791; C22C 38/06

(57) ABSTRACT

A soft-magnetic alloy according to an embodiment of the present invention has the composition of the chemical formula below.

Fe_{bal.}SiₐAl_{b}X_{c}Cr_{d} [Chemical Formula]
where X includes cobalt (Co) and/or Nickel (Ni), a is 0.25-8 wt %, b is 0.25-8 wt %, c is 0.5-10 wt % and d is 3.5-10 wt %.

### TECHNICAL FIELD

The present invention relates to a soft-magnetic alloy, and more particularly, to a soft-magnetic alloy used as a magnetic core material for electronic devices.

### BACKGROUND ART

There is a growing need for high-performance soft-magnetic materials in various electronic devices such as computers, machines, communication devices, and the like, or electronic components including the same.

For example, the soft-magnetic materials include pure iron, permalloy, sendust, amorphous alloys, nanocrystalline alloys, and the like.

Among these, sendust is a Fe—Si—Al-based soft-magnetic alloy including 9 to 10 wt % of silicon (Si) and 5 to 6 wt % of aluminum (Al), and thus has been used as a core material for magnetic heads, inductors and transformers because sendust has high magnetic permeability and excellent soft magnetic characteristics and is inexpensive.

However, sendust has a drawback in that it cannot be used as a high-frequency material having miniaturization and high-output characteristics because it has a saturation magnetic flux density of approximately 130 emu/g. Also, sendust has drawbacks in that its corrosion results in lowered saturation magnetic flux density and degraded soft magnetic characteristics because it has poor corrosion resistance. Sendust may be treated with a phosphate to enhance the corrosion resistance thereof, but it has a problem in that it has a sharply lowered saturation magnetic flux density after the phosphate treatment. Also, sendust has a problem in that its applications are limited due to poor processability during high-pressure molding.

### DISCLOSURE

### Technical Problem

Therefore, the present invention is directed to providing a soft-magnetic alloy, a soft-magnetic core, and a soft-magnetic sheet, all of which exhibit excellent corrosion resistance and have a high saturation magnetic flux density.

### Technical Solution

To solve the above problems, one aspect of the present invention provides a soft-magnetic alloy having a composition of the chemical formula below:

Fe_{bal.}SiₐAl_{b}X_{c}Cr_{d} [Chemical Formula]

wherein X comprises cobalt (Co) and/or nickel (Ni), a is in a range of 0.25 to 8% by weight, b is in a range of 0.25 to 8% by weight, c is in a range of 0.5 to 10% by weight, and d is in a range of 3.5 to 10% by weight.

The c may be in a range of 4 to 10% by weight.

The soft-magnetic alloy may have a saturation magnetic flux density of 160 emu/g or more.

Another aspect of the present invention provides a soft-magnetic core including the soft-magnetic alloy having the composition of the chemical formula below:

Fe_{bal.}SiₐAl_{b}X_{c}Cr_{d} [Chemical Formula]

wherein X comprises cobalt (Co) and/or nickel (Ni), a is in a range of 0.25 to 8% by weight, b is in a range of 0.25 to 8% by weight, c is in a range of 0.5 to 10% by weight, and d is in a range of 3.5 to 10% by weight.

The soft-magnetic core may further include a Cr₂O₃ film disposed on a surface thereof.

The soft-magnetic core may be molded using the soft-magnetic alloy.

The soft-magnetic core may be formed by winding or stacking a soft-magnetic sheet including the soft-magnetic alloy.

Still another aspect of the present invention provides a soft-magnetic sheet having a composition of the chemical formula below:

Fe_{bal.}SiₐAl_{b}X_{c}Cr_{d} [Chemical Formula]

wherein X comprises cobalt (Co) and/or nickel (Ni), a is in a range of 0.25 to 8% by weight, b is in a range of 0.25 to 8% by weight, c is in a range of 0.5 to 10% by weight, and d is in a range of 3.5 to 10% by weight.

The soft-magnetic sheet may have a Cr₂O₃ film formed on a surface thereof.

The soft-magnetic sheet may have a thickness of 50 μm or more.

### Advantageous Effects

According to exemplary embodiments of the present invention, a soft-magnetic alloy used as a magnetic core material for electronic devices or electronic components can be obtained. Particularly, according to the exemplary embodiments of the present invention, a soft-magnetic alloy which exhibits excellent corrosion resistance and has a high saturation magnetic flux density and whose applications are not limited due to high processability can be obtained.

### DESCRIPTION OF DRAWINGS

FIG. 1 shows a transformer including a soft-magnetic core according to one exemplary embodiment of the present invention.

FIG. 2 shows a soft-magnetic core manufactured from a soft-magnetic alloy according to one exemplary embodiment of the present invention.

FIG. 3 is a diagram showing a portion of a wireless power transmission device according to one exemplary embodiment of the present invention.

FIG. 4 is a diagram showing a portion of a wireless power receiving device according to one exemplary embodiment of the present invention.

FIG. 5 is a flowchart illustrating a method of manufacturing a soft-magnetic alloy according to one exemplary embodiment of the present invention.

FIG. 6 is a flowchart illustrating a method of manufacturing a soft-magnetic sheet according to one exemplary embodiment of the present invention.

FIG. 7 shows a saturation magnetic flux density of a soft-magnetic alloy manufactured in Example 1.

FIG. 8 is a graph for comparing the magnetic permeabilities of the soft-magnetic alloy of Example 1, a Fe—Si-based soft-magnetic alloy, and a molybdenum permalloy powder (MPP).

FIG. 9 is a cross-sectional view of a soft-magnetic sheet having the composition of Example 1.

FIG. 10 is a cross-sectional view of a soft-magnetic sheet having the composition of Comparative Example 1.

### MODE FOR INVENTION

The present invention may be modified in various forms and have various embodiments, and thus particular embodiments thereof will be illustrated in the accompanying drawings and described in the detailed description. However, it should be understood that the description set forth herein is not intended to limit the present invention, and encompasses all modifications, equivalents, and substitutions that do not depart from the spirit and scope of the present invention.

Although the terms encompassing ordinal numbers such as “first,” “second,” etc. may be used to describe various elements, these elements are not limited by these terms. These terms are only used for the purpose of distinguishing one element from another. For example, a first element could be termed a second element, and, similarly, a second element could be termed a first element without departing from the scope of the present invention. The term “and/or” includes any and all combinations of a plurality of associated listed items.

It will be understood that when an element is referred to as being “connected” or “coupled” to another element, it can be directly connected or coupled to the other element or intervening elements may be present. In contrast, it will be understood that when an element is referred to as being “directly connected” or “directly coupled” to another element, there are no intervening elements present.

The terminology used herein is for the purpose of describing particular embodiments only and is not intended to be limiting of exemplary embodiments. The singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, components and/or groups thereof, but do not preclude the presence or addition of one or more other features, integers, steps, operations, elements, components and/or groups thereof.

Unless defined otherwise, all the terms (including technical and scientific terms) used herein have the same meaning as commonly understood by one of ordinary skill in the art to which the present invention belongs. It will be further understood that the terms, such as those defined in commonly used dictionaries, should be interpreted as having meanings that are consistent with their meanings in the context of the relevant art, and will not be interpreted in an idealized or overly formal sense unless expressly defined otherwise herein.

Hereinafter, the embodiments of present invention will be described in detail with reference to the accompanying drawings. To aid in understanding the present invention, like numbers refer to like elements throughout the description of the figures, and the description of the same elements will be not reiterated.

A soft-magnetic alloy according to one exemplary embodiment of the present invention may be applied to soft-magnetic cores for inductors, choke coils, transformers, motors, and the like, and various sheets for shielding an electromagnetic field. For example, the soft-magnetic alloy according to one exemplary embodiment of the present invention may also be applied to soft-magnetic cores for transformers, soft-magnetic cores for motors, or magnetic cores for inductors. The soft-magnetic alloy according to one exemplary embodiment of the present invention may be applied to magnetic cores wound with a coil or magnetic cores configured to accommodate the wound coil. When the soft-magnetic alloy having a high saturation magnetic flux density is used in magnetic cores for transformers, inductors, and the like, lightweight magnetic cores may be manufactured compared to conventional materials, and may also exhibit low energy loss, that is, high-energy efficiency characteristics due to high specific resistivity characteristics. Therefore, it is possible to manufacture small, lightweight and high-efficiency magnetic cores in electronic devices. On the other hand, when the soft-magnetic alloy is used in shielding magnetic sheets, it is possible to manufacture lightweight and high-efficiency wireless charging devices due to an increase in shielding effect while decreasing a thickness of the soft-magnetic alloy.

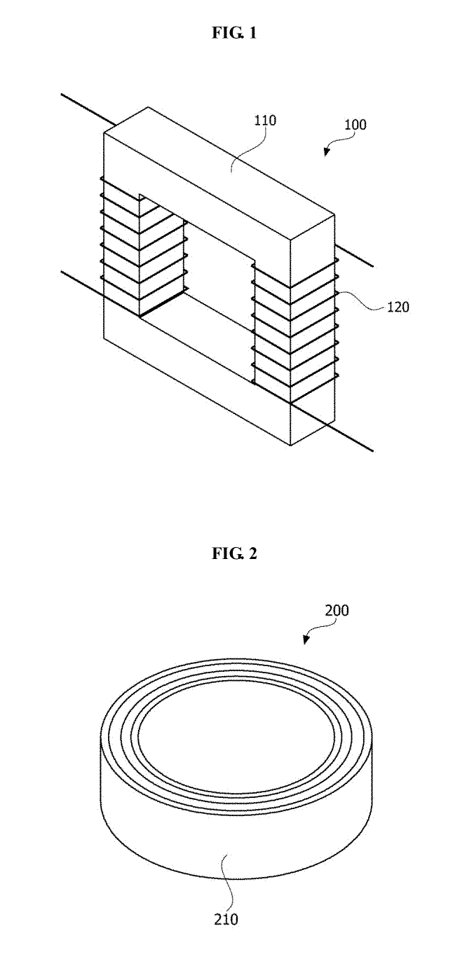

FIG. 1 shows a transformer including a soft-magnetic core according to one exemplary embodiment of the present invention.

Referring to FIG. 1, a transformer 100 inducing a change in alternating current voltage by electromagnetic induction includes a soft-magnetic core 110 and a coil 120 wound on both sides of the soft-magnetic core 110. Because a change in magnetic field generated when an alternating current is input into the primary coil has an influence on the secondary coil through the soft-magnetic core 110, a change in magnetic flux of the secondary coil induces an electric current into the secondary coil. In this case, the soft-magnetic core 110 may be molded with a powder of the soft-magnetic alloy according to one exemplary embodiment of the present invention, or may be formed by winding or stacking a soft-magnetic sheet manufactured from the soft-magnetic alloy according to one exemplary embodiment of the present invention.

FIG. 2 shows a soft-magnetic core manufactured from the soft-magnetic alloy according to one exemplary embodiment of the present invention.

Referring to FIG. 2, a soft-magnetic sheet 210 manufactured from the soft-magnetic alloy according to one exemplary embodiment of the present invention may be wound to form a soft-magnetic core 200. Such a soft-magnetic core 200 may be applied to motors, inductors, capacitors, and the like as well as transformers. Here, the soft-magnetic sheet 210 may be formed by thinly molding the soft-magnetic alloy according to one exemplary embodiment of the present invention, and thus may be used interchangeably with a soft-magnetic ribbon, a soft-magnetic plate, a soft-magnetic panel, and the like.

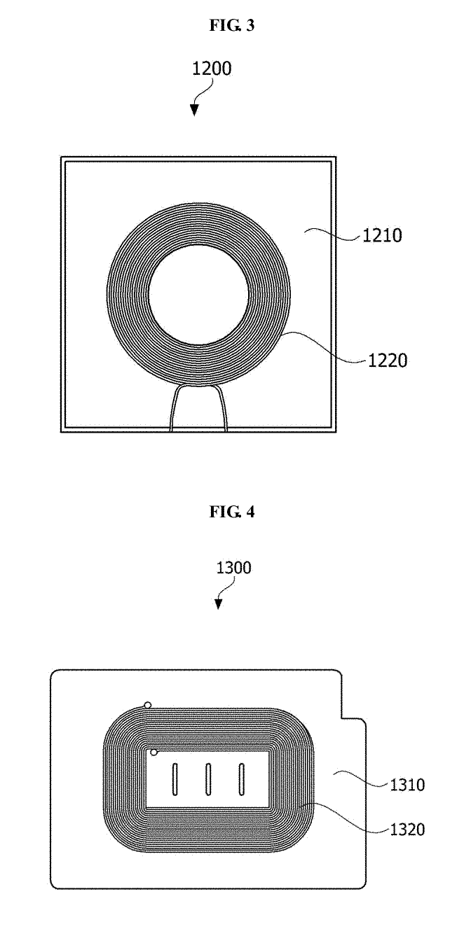

FIG. 3 is a diagram showing a portion of a wireless power transmission device according to one exemplary embodiment of the present invention, and FIG. 4 is a diagram showing a portion of a wireless power receiving device according to one exemplary embodiment of the present invention.

Referring to FIG. 3, a wireless power transmission device 1200 includes a soft-magnetic core 1210 and a transmission coil 1220.

The soft-magnetic core 1210 may be formed of a soft-magnetic material having a thickness of several millimeters (mm). The soft-magnetic core 1210 may be molded with a powder of the soft-magnetic alloy according to one exemplary embodiment of the present invention, or may be formed by winding or stacking a soft-magnetic sheet manufactured from the soft-magnetic alloy according to one exemplary embodiment of the present invention

Also, the transmission coil 1220 may be disposed on the soft-magnetic core 1210. Although not shown, a permanent magnet may be further disposed on the soft-magnetic core 1210. In this case, the permanent magnet may also be surrounded by the transmission coil 1220.

Referring to FIG. 4, a wireless power receiving device 1300 includes a soft-magnetic substrate 1310 and a receiving coil 1320. Here, the receiving coil 1320 may be disposed on the soft-magnetic substrate 1310.

The receiving coil 1320 may be formed on the soft-magnetic substrate 1310 so that the receiving coil 1320 has a coil surface wound in a direction parallel to the soft-magnetic substrate 1310. The soft-magnetic substrate 1310 may be molded with the soft-magnetic alloy according to one exemplary embodiment of the present invention, or may be formed by stacking a soft-magnetic sheet manufactured from the soft-magnetic alloy according to one exemplary embodiment of the present invention.

Although not shown, when the wireless power receiving device 1300 has both a wireless charging function and a short-range communication function, an NFC coil may be further stacked on the soft-magnetic substrate 1310. The NFC coil may be formed to surround the periphery of the receiving coil 1320.

The soft-magnetic alloy according to one exemplary embodiment of the present invention includes a soft-magnetic alloy having a composition of Chemical Formula 1 below:

Fe_{bal.}SiₐAl_{b}X_{c}Cr_{d} [Chemical Formula 1]

wherein X comprises cobalt (Co) and/or nickel (Ni), a is in a range of 0.25 to 8% by weight, b is in a range of 0.25 to 8% by weight, c is in a range of 0.5 to 10% by weight, preferably 4 to 10% by weight, and more preferably 6 to 10% by weight, and d is in a range of 3.5 to 10% by weight.

Accordingly, the soft-magnetic alloy having a saturation magnetic flux density of 160 emu/g or more and exhibiting excellent corrosion resistance and processability may be obtained.

More specifically, the soft-magnetic alloy according to one exemplary embodiment of the present invention includes 0.25 to 8% by weight of Si. Si serves to increase electric resistivity, reduce excess current loss and enhance magnetic permeability. Also, Si serves to suppress a change in magnetic characteristics according to an environment and enhance strength against impact. When Si is included at a content of less than 0.25% by weight, an effect of improving magnetic anisotropy, magnetostriction, and specific resistivity may be remarkably compromised. On the other hand, when Si is included at a content of greater than 8% by weight, moldability of the soft-magnetic alloy may be degraded due to increased elasticity of the soft-magnetic alloy.

Also, the soft-magnetic alloy according to one exemplary embodiment of the present invention includes 0.25 to 8% by weight of Al. When Al is included at a content of less than 0.25% by weight, an effect of improving magnetic anisotropy, magnetostriction, and specific resistivity may be remarkably compromised. On the other hand, when Al is included at a content of greater than 8% by weight, moldability of the soft-magnetic alloy may be degraded due to increased elasticity of the soft-magnetic alloy.

In addition, the soft-magnetic alloy according to one exemplary embodiment of the present invention includes 0.5 to 10% by weight, preferably 4 to 10% by weight, and more preferably 6 to 10% by weight of Co and/or Ni. Because Co and Ni are ferromagnetic elements, they serve to increase a saturation magnetic flux density. When Co and/or Ni are included at a content of less than 0.5% by weight, an effect of increasing a saturation magnetic flux density may be compromised. On the other hand, when Co and/or Ni are included at a content of greater than 10% by weight, an excessive rise in costs of raw materials may be caused.

Further, the soft-magnetic alloy according to one exemplary embodiment of the present invention includes 3.5 to 10% by weight of Cr. Cr serves as a growth inhibitor, and also serves to improve electric resistivity and enhance corrosion resistance by forming an oxide film on the soft-magnetic alloy. For example, Cr may serve to prevent corrosion that may be caused during a process of manufacturing or drying a soft-magnetic alloy including Fe. Therefore, when Cr is included at a content of less than 3.5% by weight, Cr may also serve as a seed for corrosion, resulting in degraded corrosion resistance of the soft-magnetic alloy. However, when Cr is included at a content of greater than 10% by weight, moldability and a saturation magnetic flux density may be lowered, and an excessive rise in costs of raw materials may be caused.

FIG. 5 is a flowchart illustrating a method of manufacturing a soft-magnetic alloy according to one exemplary embodiment of the present invention.

Referring to FIG. 5, metal powders according to the composition of Chemical Formula 1 are mixed in a melting furnace, and melted at 1,500° C. to 1,900° C. (S500).

Next, the resulting melt solution is quickly cooled to produce an alloy powder (S510). For this purpose, a gas or water including N₂ and/or Ar may be sprayed onto the melt solution.

Then, the alloy powder is thermally treated at a temperature of 300 to 1,000° C. for 5 minutes to 24 hours (S520). The thermal treatment may be carried out in a magnetic or non-magnetic field under a gas atmosphere including H₂, N₂, Ar and/or NH₃. In this case, when a thermal treatment time is less than 5 minutes, an effect of improving soft magnetic characteristics through the thermal treatment may be compromised. Also, when a thermal treatment temperature is less than 300° C., economic feasibility may be degraded due to a long thermal treatment time. On the other hand, when the thermal treatment temperature is greater than 1,000° C., the alloy powder may be melted again.

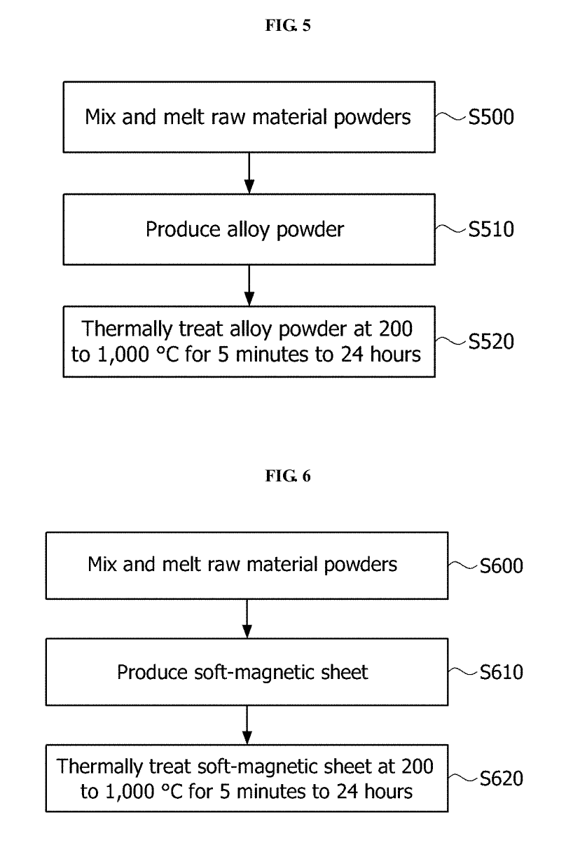

FIG. 6 is a flowchart illustrating a method of manufacturing a soft-magnetic sheet according to one exemplary embodiment of the present invention.

Referring to FIG. 6, metal powders according to the composition of Chemical Formula 1 are mixed in a melting furnace, and melted at 1,500° C. to 1,900° C. (S600).

Next, the resulting melt solution is cast to produce a soft-magnetic sheet having a predetermined thickness (S610). For this purpose, the melt solution may be put into a mold, and quickly cooled. Here, the thickness of the soft-magnetic sheet may vary depending on the application thereto. For example, the thickness of the soft-magnetic sheet may be in a range of 50 μm or more, preferably 100 μm or more.

Then, the soft-magnetic sheet is thermally treated at a temperature of 300 to 1,000° C. for 5 minutes to 24 hours (S620). The thermal treatment may be carried out in a magnetic or non-magnetic field under a gas atmosphere including H₂, N₂, Ar and/or NH₃. In this case, when a thermal treatment time is less than 5 minutes, an effect of improving soft magnetic characteristics through the thermal treatment may be compromised. Also, when a thermal treatment temperature is less than 300° C., economic feasibility may be degraded due to a long thermal treatment time. On the other hand, when the thermal treatment temperature is greater than 1,000° C., the alloy powder may be melted again.

The soft-magnetic core according to one exemplary embodiment of the present invention may be manufactured by molding the soft-magnetic alloy manufactured according to the method shown in FIG. 5 or winding or stacking the soft-magnetic sheet manufactured according to the method shown in FIG. 6.

Hereinafter, the present invention will be described in further detail with reference to examples and comparative examples thereof.

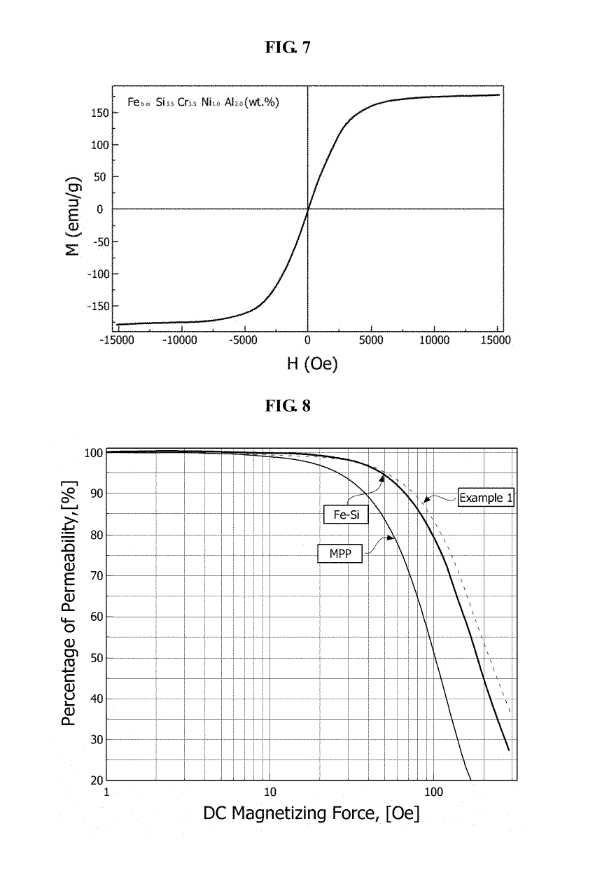

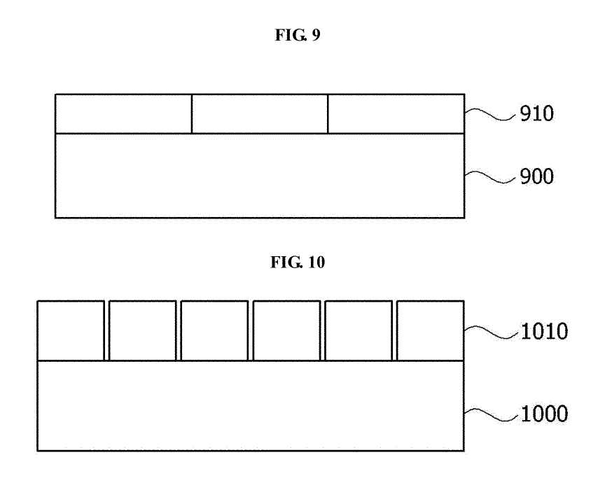

Table 1 lists compositions, saturation magnetic flux densities (T) and corrosion resistances of the soft-magnetic alloys according to the examples. Table 2 lists compositions, saturation magnetic flux densities (T) and corrosion resistances of the soft-magnetic alloys according to the comparative examples. Also, FIG. 7 shows a saturation magnetic flux density of the soft-magnetic alloy of Example 1, FIG. 8 is a graph for comparing magnetic permeabilities of the soft-magnetic alloy of Example 1, a Fe—Si-based soft-magnetic alloy, and a molybdenum permalloy powder (MPP), FIG. 9 is a cross-sectional view of a soft-magnetic sheet having the composition of Example 1, and FIG. 10 is a cross-sectional view of a soft-magnetic sheet having the composition of Comparative Example 1.

The soft-magnetic alloys according to the examples and the comparative examples were manufactured according to the method of FIG. 5 using the metal powders according to the respective compositions, and the soft-magnetic sheets according to the examples and the comparative examples were manufactured according to the method of FIG. 6 using the metal powders according to the respective compositions.

The saturation magnetic flux densities (T) of the soft-magnetic alloys manufactured according to the examples and the comparative examples were measured using vibrating sample magnetometer (VSM) equipment. Also, the corrosion resistances of the soft-magnetic sheets according to the examples and the comparative examples were treated for 48 hours with saline including 5% by weight of NaCl, and then measured by observing a degree of corrosion.

TABLE 1

| | | Saturation | |
|---|---|---|---|
| | | magnetic | |
| | | flux density | Corrosion |
| Test No. | Composition (at. %) | (emu/g) | resistance |
| Example 1 | Fe_{bal.}Si_{3.5}Al_{2.0}Ni_{1.0}Cr_{3.5} | 170 | Good |
| Example 2 | Fe_{bal.}Si_{3.5}Al_{2.0}Ni_{5.0}Cr_{3.5} | 180 | Good |
| Example 3 | Fe_{bal.}Si_{1.5}Al_{7.0}Ni_{7.0}Cr_{5.0} | 180 | Good |
| Example 4 | Fe_{bal.}Si_{7.0}Al_{7.0}Ni_{1.0}Cr_{5.0} | 160 | Good |

TABLE 2

| | | Saturation | |
|---|---|---|---|
| | | magnetic | |
| | | flux density | Corrosion |
| Test No. | Composition (at. %) | (emu/g) | resistance |
| Comparative | Fe_{bal.}Si_{1.5}Al_{0.25}Ni_{1.0}Cr_{0.25} | 190 | Poor |
| Example 1 | | | |
| Comparative | Fe_{bal.}Si_{10.0}Al_{5.0} | 129 | Poor |
| Example 2 | | | |
| Comparative | Fe_{bal.}Si_{11.0}Al_{2.0} | 140 | Poor |
| Example 3 | | | |

Referring to Tables 1 and 2 and FIG. 7, it can be seen that the soft-magnetic alloys of Examples 1 to 4 having the composition of Chemical Formula 1 had a saturation magnetic flux density of 160 emu/g and exhibited excellent corrosion resistance, but the soft-magnetic alloys of Comparative Examples 1 to 3 whose compositions were out of these numerical ranges had poor saturation magnetic flux density and/or corrosion resistance.

In particular, it can be seen that the soft-magnetic alloys had a saturation magnetic flux density of 180 emu/g or more when the soft-magnetic alloys included 5.0% by weight of Ni as in Example 2 or 7.0% by weight of Ni as in Example 3. From the results, it can be seen that the soft-magnetic alloys had a high saturation magnetic flux density even when Fe was included at a relatively low content when the ferromagnetic element Co or Ni was included at a content of 0.25 to 10% by weight, preferably 4 to 10% by weight, and more preferably 6 to 10% by weight. Therefore, when Cr was included at a content of 3.5% by weight or more, it was possible to enhance corrosion resistance and maintain the saturation magnetic flux density at a high level as well.

Referring to FIG. 8, it can also be seen that the soft-magnetic alloy according to Example 1 exhibited high magnetic permeability, compared to the conventional silicon steel (Fe—Si) or molybdenum permalloy powder (MPP).

Particularly, when Cr is included at a content of less than 3.5% by weight as in Comparative Example 1, the saturation magnetic flux density may increase but the corrosion resistance may be degraded due to a relative increase in content of Fe. That is, at the beginning of corrosion, a porous Fe₂O₃ film 1010 may be formed on a soft-magnetic sheet 1000 having the composition of Comparative Example 1, as shown in FIG. 10. Thus, the soft-magnetic sheet 1000 becomes easily rusted because oxygen may easily penetrate into the soft-magnetic sheet 1000 through the porous Fe₂O₃ film 1010.

On the other hand, when Cr is included at a content of 3.5% by weight or more as in Example 1, a thin and compact Cr₂O₃ film 910 may be formed on a soft-magnetic sheet 900 at the beginning of corrosion, as shown in FIG. 9. Therefore, additional corrosion may be prevented or delayed because oxygen does not easily penetrate into the soft-magnetic sheet 900.

The soft-magnetic alloy or the soft-magnetic sheet according to one exemplary embodiment of the present invention may be applied to various sheets for shielding an electromagnetic field. For example, the soft-magnetic alloy or the soft-magnetic sheet according to one exemplary embodiment of the present invention may also be applied to shielding sheets for radio frequency identification (RFID) antennas, or wireless charging shielding sheets.

Also, the soft-magnetic alloy or the soft-magnetic sheet according to one exemplary embodiment of the present invention or the soft-magnetic core including the same may be applied to soft-magnetic cores for transformer, soft-magnetic cores for motors, or magnetic cores for inductors. For example, the soft-magnetic alloy according to one exemplary embodiment of the present invention may be applied to magnetic cores wound with a coil or magnetic cores configured to accommodate the wound coil.

Further, the soft-magnetic alloy according to one exemplary embodiment of the present invention may also be widely applied to eco-friendly cars, high-performance electronic devices, and the like.

While the present invention has been shown and described with reference to certain exemplary embodiments thereof, it will be understood by those skilled in the art that various changes in form and details may be made therein without departing from the spirit and scope of the invention as defined by the appended claims.

1. A soft-magnetic alloy having a composition of the chemical formula below:
Fe_{bal.}SiₐAl_{b}X_{c}Cr_{d} [Chemical Formula]
wherein X comprises cobalt (Co) and/or nickel (Ni), a is in a range of 0.25 to 8% by weight, b is in a range of 0.25 to 8% by weight, c is in a range of 0.5 to 10% by weight, and d is in a range of 3.5 to 10% by weight.

2. The soft-magnetic alloy of claim 1, wherein the c is in a range of 4 to 10% by weight.

3. The soft-magnetic alloy of claim 1, which has a saturation magnetic flux density of 160 emu/g or more.

4. A soft-magnetic core comprising a soft-magnetic alloy having the composition of the chemical formula below:
Fe_{bal.}SiₐAl_{b}X_{c}Cr_{d} [Chemical Formula]
wherein X comprises cobalt (Co) and/or nickel (Ni), a is in a range of 0.25 to 8% by weight, b is in a range of 0.25 to 8% by weight, c is in a range of 0.5 to 10% by weight, and d is in a range of 3.5 to 10% by weight.

5. The soft-magnetic core of claim 4, wherein the c is in a range of 4 to 10% by weight.

6. The soft-magnetic core of claim 4, which has a saturation magnetic flux density of 160 emu/g or more.

7. The soft-magnetic core of claim 4, further comprising a Cr₂O₃ film disposed on a surface thereof.

8. The soft-magnetic core of claim 4, which is formed of the soft-magnetic alloy.

9. The soft-magnetic core of claim 4, which is formed by winding or stacking a soft-magnetic sheet comprising the soft-magnetic alloy.

10. A soft-magnetic sheet having a composition of the chemical formula below:
Fe_{bal.}SiₐAl_{b}X_{c}Cr_{d} [Chemical Formula]
wherein X comprises cobalt (Co) and/or nickel (Ni), a is in a range of 0.25 to 8% by weight, b is in a range of 0.25 to 8% by weight, c is in a range of 0.5 to 10% by weight, and d is in a range of 3.5 to 10% by weight.

11. The soft-magnetic sheet of claim 10, wherein the c is in a range of 4 to 10% by weight.

12. The soft-magnetic sheet of claim 10, which has a saturation magnetic flux density of 160 emu/g or more.

13. The soft-magnetic sheet of claim 10, further comprising a Cr₂O₃ film disposed on a surface thereof.

14. The soft-magnetic sheet of claim 10, which has a thickness of 50 μm or more.
